(19) United States
(12) Patent Application Publication
(10) Pub. No.: US 2015/0002251 A1
(43) Pub. Date: Jan. 1, 2015

(54) MAGNETIC CORE AND MAGNETIC ELEMENT USING SAME

(71) Applicant: DELTA ELECTRONICS, INC., Taoyuan Hsien (TW)

(72) Inventors: Han-Hsing Lin, Taoyuan Hsien (TW); Yu-Chun Lai, Taoyuan Hsien (TW); Yi-Lin Chen, Taoyuan Hsien (TW); Chia-Ming Liu, Taoyuan Hsien (TW); Chih-Ming Chen, Taoyuan Hsien (TW); Chien-Hung Liu, Taoyuan Hsien (TW)

(73) Assignee: DELTA ELECTRONICS, INC., Taoyuan Hsien (TW)

(21) Appl. No.: 14/025,153

(22) Filed: Sep. 12, 2013

(30) Foreign Application Priority Data
Jun. 28, 2013 (TW) 102123117

(51) Int. Cl. H01F 3/00

(52) U.S. Cl. CPC H01F 3/00
USPC 335/297

(57) ABSTRACT

A magnetic core includes an ellipse-shaped central post and two side posts. The ellipse-shaped central post includes a long axis and a short axis. The length of the long axis is greater than the length of the short axis. The two side posts are disposed on two sides of the ellipse-shaped central post and opposite to each other. The two side posts are connected with the ellipse-shaped central post through two connecting portions respectively for defining at least one winding space with the ellipse-shaped central post. By utilizing the ellipse-shaped central post, the volume of the winding space is increased, the diameter of the wire of the winding coil can be increased, the temperature of the winding encapsulation is easy to be lowered, the over-volume issue of the winding encapsulation is avoided, and the safe distance between the bobbin and the winding encapsulation is increased, so that the present disclosure meets the safety regulation.

### TECHNICAL FIELD

The present disclosure relates to a magnetic core, and more particularly to a magnetic core including an ellipse-shaped central post and a magnetic element using the same.

### BACKGROUND

Magnetic elements are the basic components of electronic devices. The magnetic elements are widely utilized to lot types of electronic devices. With the trends of miniaturization, high power, multi functions and popularization, the magnetic elements are flat designed, the performance is required to be enhanced, the structure diversity is required to be promoted, and the costs are required to be reduced.

Please refer to FIG. 1A. FIG. 1A schematically illustrates the structure of a magnetic core of a traditional magnetic element. In general, a magnetic core 1 may include a middle post 11 and two lateral posts 12. A winding region 13 is defined by the middle post 11 and the two lateral posts 12 for a coil to wind around. Please refer to FIG. 1B. FIG. 1B schematically illustrates a top view of the magnetic core as shown in FIG. 1A. Since the middle post 11 is circle-shaped, the winding region 13, which is defined by the middle post 11 and the two lateral posts 12, is almost full filled with the winding encapsulation when the coil is winding around. Each lap of the coil and the middle post 11 are substantially concentric circles, so that the winding region 13 is completely used.

However, there are still some drawbacks of the magnetic core 1 mentioned above. Since the winding region 13 is defined by the middle post 11 and the two lateral posts 12, the lateral winding space is relatively smaller and cannot be increased for meeting different demands. Furthermore, under the trends of high efficiency and high power transformers, the lap amount of the coil of the magnetic core and the magnetic element is usually higher, which causes the winding encapsulation too much larger, and even causes the problems of inadequate distance between the winding encapsulation and the bobbin and high temperature and high heat-dissipation difficulty of the winding encapsulation.

For example, the distance between the winding encapsulation and the bobbin may be less than 0.2 mm, which is not complied with the safety regulations. Meanwhile, the diameter of the winding wire of the coil is relatively smaller and not easy to be increased for meeting different demands of practical requirements due to the shape factor of the circle-shaped middle post 12, so the efficiency is not easy to be enhanced at all. Additionally, it is well known that the magnetic induction intensity (i.e. ΔB) and the performance of the magnetic core consumption of a circle-shaped middle post 12 must be improved.

There is a need of providing a magnetic core and a magnetic element using the same to obviate the drawbacks encountered from the prior art.

### BRIEF SUMMARY

The present disclosure provides a magnetic core and a magnetic element using the same in order to eliminate the drawbacks of smaller space of winding region, smaller diameter of winding wire, large volume and high heat-dissipation difficulty of winding encapsulation, inadequate distance between the winding encapsulation and the bobbin, and the low magnetic induction intensity and the bad performance of the magnetic core consumption.

The present disclosure also provides a magnetic core and a magnetic element using the same. By utilizing the ellipse-shaped central post, the volume of the winding space is increased, so that the diameter of the wire of the winding coils can be increased, the temperature of the winding encapsulation is easy to be lowered, the over-volume issue of the winding encapsulation is avoided, and the safe distance between the bobbin and the winding encapsulation is increased, so that the present disclosure meets the safety regulation.

The present disclosure further provides a magnetic core and a magnetic element using the same. Since the two side posts are disposed on the extension of the short axis, the lengths of the long axis and the short axis are adjustable so as to be designed or adjusted to meet the demands of the winding space. Therefore, the magnetic induction intensity is increased, and the performance of the magnetic core consumption is improved.

The present disclosure further provides a magnetic core and a magnetic element using the same. Via the utilization of the lead angle of the two side posts, the winding coil is much more easier to be wound, and the safety during assembling is also enhanced.

In accordance with an aspect of the present disclosure, there is provided a magnetic core. The magnetic core includes an ellipse-shaped central post and two side posts. The ellipse-shaped central post includes a long axis and a short axis, among which the length of the long axis is greater than the length of the short axis. The two side posts are disposed on the two sides of the ellipse-shaped central post and opposite to each other. The two side posts are connected with the ellipse-shaped central post through two connecting portions for defining at least one winding space with the ellipse-shaped central post.

In accordance with another aspect of the present disclosure, there is provided a magnetic element. The magnetic element includes a magnetic core assembly including a first magnetic core and a second magnetic core and at least one winding coil. The first magnetic core and the second magnetic core are structurally matched with each other, among which each of the first magnetic core and the second magnetic core includes an ellipse-shaped central post and two side posts. The ellipse-shaped central post includes a long axis and a short axis, among which the length of the long axis is greater than the length of the short axis. The two side posts are disposed on the two sides of the ellipse-shaped central post and opposite to each other. The two side posts are connected with the ellipse-shaped central post through two connecting portions for defining at least one winding space with the ellipse-shaped central post. The winding coil is at least partially received by the winding space of the first magnetic core and the winding space of the second magnetic core.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1A schematically illustrates the structure of a magnetic core of a traditional magnetic element;

FIG. 1B schematically illustrates a top view of the magnetic core as shown in FIG. 1A;

FIG. 2A schematically illustrates the structure of a magnetic core according to an embodiment of the present disclosure;

FIG. 2B schematically illustrates a top view of the magnetic core as shown in FIG. 2A;

FIG. 3 schematically illustrates the structures of a magnetic core and another magnetic core structurally matched with each other according to an embodiment of the present disclosure;

FIG. 4 schematically illustrates the structures of a magnetic core and another magnetic core structurally matched with each other according to another embodiment of the present disclosure; and

FIG. 5 schematically illustrates an assembled structure of a magnetic element according to an embodiment of the present disclosure.

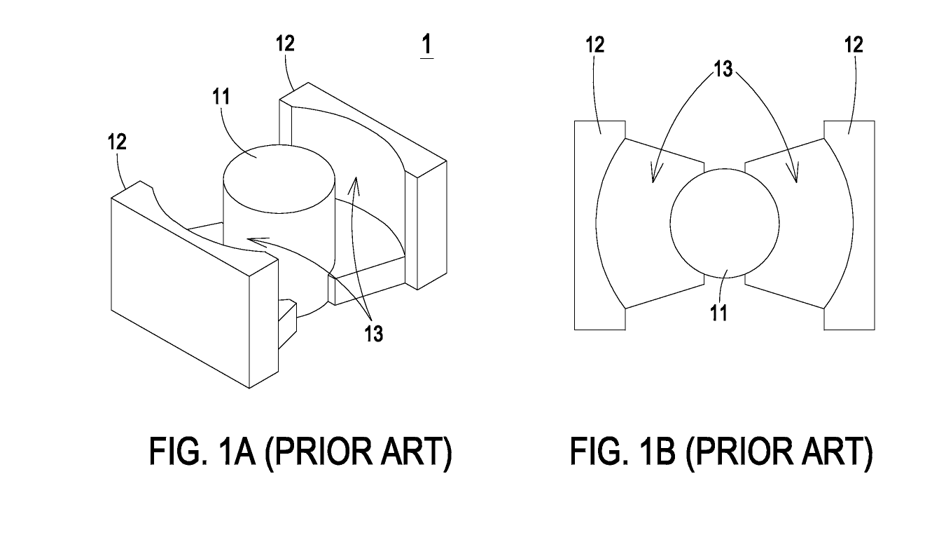

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

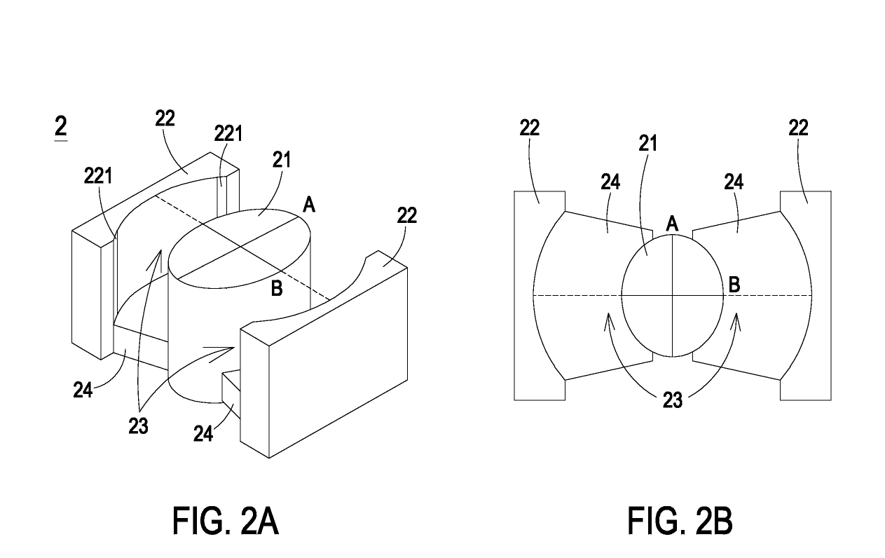

Please refer to FIG. 2A and FIG. 2B. FIG. 2A schematically illustrates the structure of a magnetic core according to an embodiment of the present disclosure. FIG. 2B schematically illustrates a top view of the magnetic core as shown in FIG. 2A. As shown in FIG. 2A and FIG. 2B, the magnetic core 2 of the present disclosure includes an ellipse-shaped central post 21 and two side posts 22. The ellipse-shaped central post 21 includes a long axis A and a short axis B, among which the length of the long axis A is greater than the length of the short axis B. The two side posts 22 are disposed on the two sides of the ellipse-shaped central post 21 and opposite to each other. The two side posts 22 are connected with the ellipse-shaped central post 21 through two connecting portions 24 for defining at least one winding space 23 with the ellipse-shaped central post 21. For example, the winding space 23 may be used for receiving a primary winding coil or a secondary winding coil. By utilizing the ellipse-shaped central post 21, the space/volume of the winding space 23 is increased, so that the diameter of the wire of the winding coils can be increased, the temperature of the winding encapsulation is easy to be lowered, the over-volume issue of the winding encapsulation is avoided, and the safe distance between the bobbin and the winding encapsulation is increased, so that the present disclosure meets the safety regulation.

Additionally, the magnetic core 2 further includes two connecting portions 24. The two side posts 22 are disposed on the extension of the short axis B and connected with the ellipse-shaped central post 21 through the two connecting portions 24. In some embodiments, the ellipse-shaped central post 21, the two side posts 22 and the two connecting portions 24 of the magnetic core 2 are integrally formed, but not limited thereto. In some embodiments, the ellipse-shaped central post 21, the two side posts 22 and the two connecting portions 24 are made of magnetically conductive metal material (e.g. iron, ferrite or the like).

Preferably, each of the two side posts 22 of the magnetic core 2 includes at least one lead angle 221 for guiding the winding coil and enhancing the safety during assembling. The lead angle 221 is preferably an obtuse angle, but not limited thereto. In this embodiment, each of the two side posts 22 includes a lead angle 221, and the degree of the lead angle 221 is greater than 90. Via the utilization of the lead angle 221 of the two side posts 22, the winding coil is much more easier to be wound, and the safety during assembling is also enhanced.

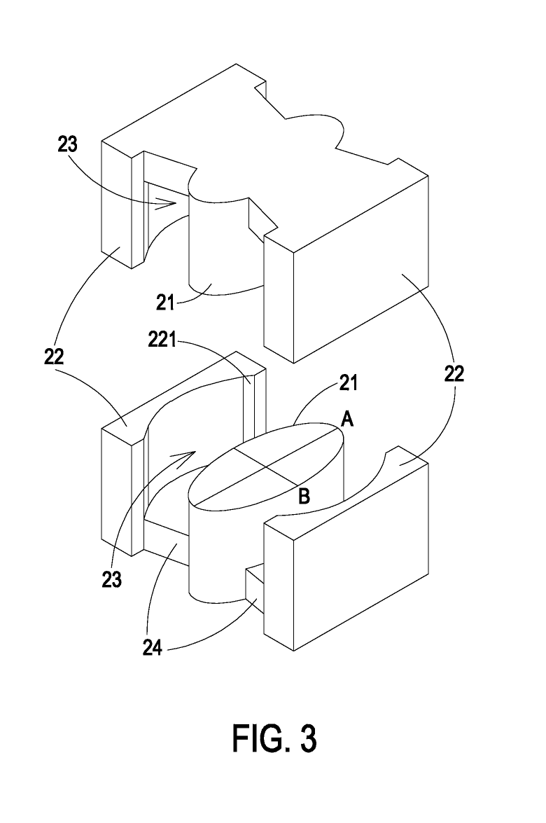

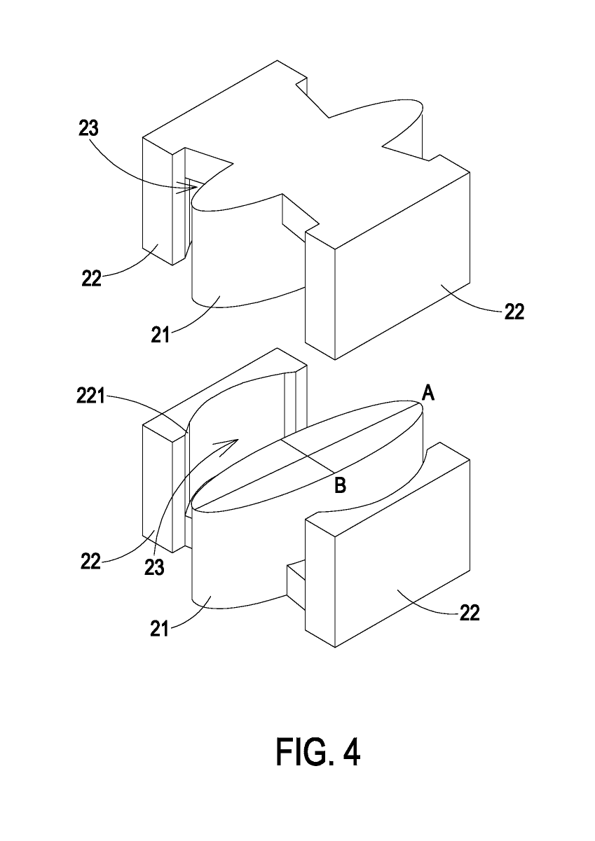

Please refer to FIG. 3 and FIG. 4. FIG. 3 schematically illustrates the structures of a magnetic core and another magnetic core structurally matched with each other according to an embodiment of the present disclosure. FIG. 4 schematically illustrates the structures of a magnetic core and another magnetic core structurally matched with each other according to another embodiment of the present disclosure. The magnetic core 2 and another magnetic core matched with the magnetic core 2 are structurally and exteriorly matched with each other. In other words, the magnetic core 2 and another magnetic core matched with the magnetic core 2 may be regarded as having the same exteriors and structures. The only difference between these two magnetic cores is that the magnetic core matched with the magnetic core 2 is placed upside down. The magnetic core matched with the magnetic core 2 is also called “magnetic core 2” hereinafter. In this embodiment, the features, the components, the structure and the relationship between the components of the magnetic core 2 are similar to the above-mentioned embodiments, and are not redundantly described herein.

It should be noted that the length of the long axis A of the ellipse-shaped central post 21 of the magnetic core 2 shown in FIG. 4 is greater than the length of the long axis A of the ellipse-shaped central post 21 of the magnetic core 2 shown in FIG. 3, such that the volume of the winding space 23 of the magnetic core 2 shown in FIG. 4 is greater than the volume of the winding space 23 of the magnetic core 2 shown in FIG. 3. Simultaneously, the length of the short axis B shown in FIG. 4 is less than the length of the short axis B shown in FIG. 3. In brief, the length of the short axis B is decreased and the volume of the winding space 23 is increased when the length of the long axis A is increased, and the length of the short axis B is increased and the volume of the winding space 23 is decreased when the length of the long axis A is decreased. Since the two side posts 22 are disposed on the extension of the short axis B, the lengths of the long axis A and the short axis B are adjustable so as to be designed or adjusted to meet the demands of the winding space 23. Therefore, the magnetic induction intensity is increased, and the performance of magnetic core consumption is improved.

In some embodiments, the ellipse-shaped central post 21 is at least partially exposed outside the two side posts 22, so that the length of the long axis A and the length of the short axis B can be adjusted for meeting the demands of practical requirements of a magnetic element.

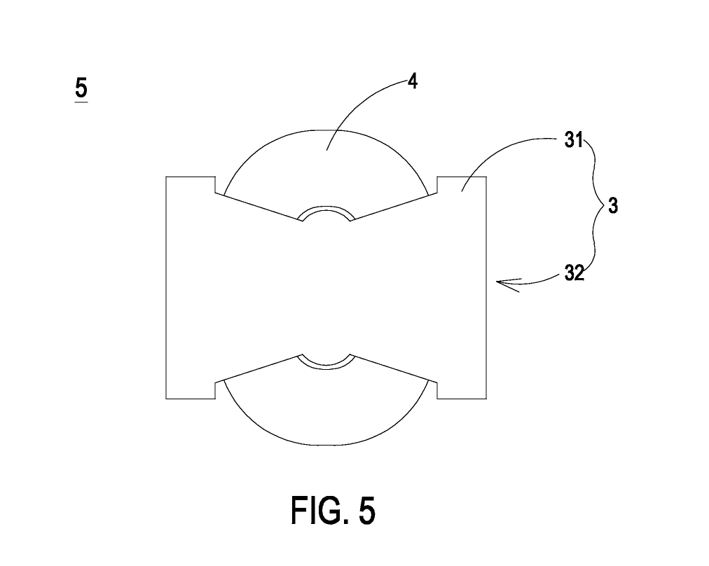

Please refer to FIG. 3 and FIG. 5. FIG. 5 schematically illustrates an assembled structure of a magnetic element according to an embodiment of the present disclosure. As shown in FIG. 3 and FIG. 5, a magnetic element 5 of the present disclosure includes a magnetic core assembly 3 and at least one winding coil 4. The magnetic core assembly 3, which is preferably a PQ type magnetic core assembly, an EE type magnetic core assembly, an UI type magnetic core assembly or an EI type magnetic core assembly, includes a first magnetic core 31 and a second magnetic core 32 (in FIG. 5 the second magnetic core 32 is hided by the first magnetic core 31), among which the first magnetic core 31 and the second magnetic core 32 are structurally matched with each other. That is to say, the first magnetic core 31 and the second magnetic core 32 have the similar exteriors and structures.

In this embodiment, the features, the components, the structure and the relationship between the components of the first magnetic core 31 and the second magnetic core 32 are similar to the magnetic core 2 as described in the embodiments mentioned above, and are not redundantly described herein. On the other hand, the winding coil 4 is at least partially received by the winding space of the first magnetic core 31 and the winding space of the second magnetic core 32, and further assembled into the magnetic element 5 of the present disclosure.

Moreover, the ellipse-shaped central post and the two side posts of the first magnetic core 31 and/or the ellipse-shaped central post and the two side posts of the second magnetic core 32 are integrally formed, but not limited thereto. In some embodiments, the magnetic core assembly 5 is made of magnetically conductive metal material or ferrite material.

From the above description, the present disclosure provides a magnetic core and a magnetic element using the same. By utilizing the ellipse-shaped central post, the volume of winding space is increased, so that the diameter of the wire of the winding coils can be increased, the temperature of the winding encapsulation is easy to be lowered, the over-volume issue of the winding encapsulation is avoided, and the safe distance between the bobbin and the winding encapsulation is increased, so that the present disclosure meets the safety regulation. Meanwhile, via the utilization of the lead angle of the two side posts, the winding coil is much more easier to be wound, and the safety during assembling is also enhanced. In addition, since the two side posts are disposed on the extension of the short axis, the lengths of the long axis and the short axis are adjustable so as to be designed or adjusted to meet the demands of the winding space. Therefore, the magnetic induction intensity is increased, and the performance of the magnetic core consumption is improved.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic core, comprising:
an ellipse-shaped central post having a long axis and a short axis, wherein the length of said long axis is greater than the length of said short axis; and
two side posts disposed on two sides of said ellipse-shaped central post and opposite to each other, wherein said two side posts are connected with said ellipse-shaped central post through two connecting portions respectively for defining at least one winding space with said ellipse-shaped central post.

2. The magnetic core according to claim 1, wherein said two side posts are disposed on the extension of said short axis.

3. The magnetic core according to claim 1, wherein the length of said short axis is decreased and the volume of said winding space is increased when the length of said long axis is increased, and the length of said short axis is increased and the volume of said winding space is decreased when the length of said long axis is decreased.

4. The magnetic core according to claim 1, wherein said ellipse-shaped central post, said two side posts and said two connecting portions are integrally formed.

5. The magnetic core according to claim 1, wherein said ellipse-shaped central post, said two side posts and said two connecting portions are made of magnetically conductive metal material.

6. The magnetic core according to claim 1, wherein said ellipse-shaped central post is at least partially exposed outside said two side posts.

7. The magnetic core according to claim 1, wherein each of said two side posts includes at least one lead angle.

8. A magnetic element, comprising:
a magnetic core assembly comprising a first magnetic core and a second magnetic core, wherein said first magnetic core and said second magnetic core are structurally matched with each other, and each of said first magnetic core and said second magnetic core comprises:
an ellipse-shaped central post having a long axis and a short axis, wherein the length of said long axis is greater than the length of said short axis; and
two side posts disposed on two sides of said ellipse-shaped central post and opposite to each other, wherein said two side posts are connected with said ellipse-shaped central post through two connecting portions respectively for defining at least one winding space with said ellipse-shaped central post; and
at least one winding coil at least partially received by said winding space of said first magnetic core and said winding space of said second magnetic core.

9. The magnetic element according to claim 8, wherein said magnetic core assembly is a PQ type magnetic core assembly, an EE type magnetic core assembly, an UI type magnetic core assembly or an EI type magnetic core assembly.

10. The magnetic element according to claim 8, wherein said ellipse-shaped central post, said two connecting portions and said two side posts are integrally formed.

11. The magnetic element according to claim 8, wherein said magnetic core assembly is made of magnetically conductive metal material or ferrite material.

12. The magnetic element according to claim 8, wherein each of said two side posts includes a lead angle, and the degree of said lead angle is greater than 90.

13. The magnetic element according to claim 8, wherein said ellipse-shaped central post is at least partially exposed outside said two side posts.
